(19) United States
(12) Patent Application Publication
(10) Pub. No.: US 2009/0102141 A1
(43) Pub. Date: Apr. 23, 2009

(54) Low Load Annular Gasket

(75) Inventor: John B. Wagner, Greenfield, IN (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/875,175

(22) Filed: Oct. 19, 2007

(51) Int. Cl. F16J 15/02

(52) U.S. Cl. 277/650

(57) ABSTRACT

A cap for a fuel tank filler neck includes a stem portion adapted for threaded engagement with the fuel tank filler neck, and an annular gasket. The stem portion includes an upper rim and a lower rim forming an annular groove adapted to receive the annular gasket. The annular gasket includes an upper flange having an upper lip, a lower flange, and a body portion interconnecting the upper flange and the lower flange to form a substantially horseshoe-shaped cross section. The lower flange may resiliently deflect inward in response to a compression load between the upper rim and a seal surface disposed on the filler neck. The compression load causes the lower flange and the upper lip to seal against the seal surface.

### FIELD

The present disclosure relates to gaskets, and in particular, to a low load O-ring.

### BACKGROUND

The statements in this section merely provide background information related to the present disclosure and may not constitute prior art.

Filler neck openings of liquid and gas containers, especially vehicle fuel tank filler neck openings, are typically sealed with a cap including an annular gasket, or O-ring, disposed around a threaded stem of the cap. Such annular gaskets may have a generally crescent or C-shaped cross section, as is known in the art.

Threaded vehicle fuel caps typically engage a fuel tank filler neck opening with corresponding female threads and often must be tightened to a high torque to provide a sufficient compression load on the o-ring to ensure proper sealing of the fuel tank filler neck opening.

### SUMMARY

A cap for a fuel tank filler neck includes a stem portion adapted for threaded engagement with the fuel tank filler neck, and an annular gasket/seal/O-ring. The stem portion includes an upper rim and a lower rim forming an annular groove adapted to receive the annular gasket/seal/O-ring (hereinafter simply referred to as “annular gasket”). The annular gasket includes an upper flange having an upper lip, a lower flange, and a body portion interconnecting the upper flange and the lower flange to form a substantially horseshoe-shaped cross section. The lower flange may resiliently deflect inward in response to a compression load between the upper rim and a seal surface disposed on the filler neck. The compression load causes the lower flange and the upper lip to seal against the seal surface.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of an internal combustion engine and a fuel tank with a filler neck and a cap according to the principles of the present disclosure;

FIG. 2 is partial cross-sectional view of a fuel cap seal system according to the principles of the present disclosure;

FIG. 3 is cross-sectional view of an annular gasket according to the principles of the present disclosure; and

FIG. 4 is cross-sectional view of the annular gasket of FIG. 3 in a loaded condition according to the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

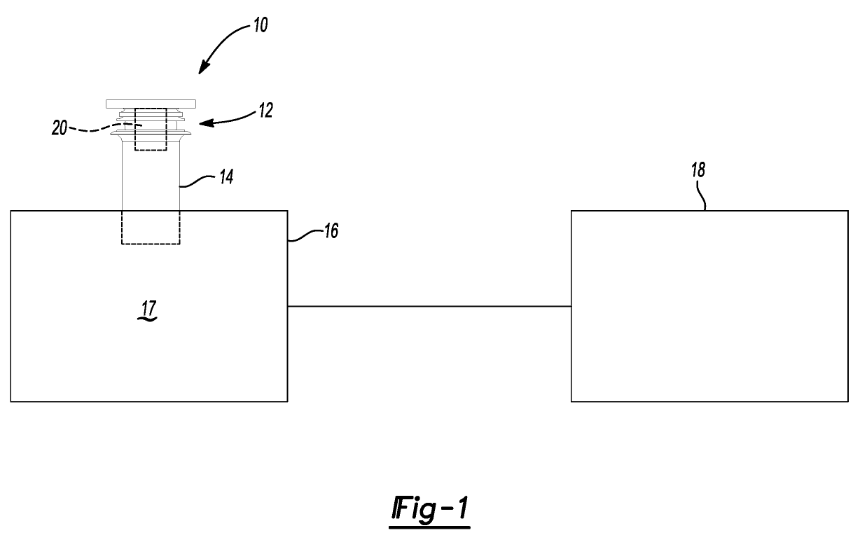

Referring to FIGS. 1-4, a fuel cap 10 is provided and includes an annular gasket 12 (or seal or O-ring) which may be disposed around a portion of the fuel cap 10. The fuel cap 10 may be installed on a filler neck 14, which is in fluid communication with a fuel tank 16 comprising a cavity 17 adapted to contain fuel. The annular gasket 12 is operable to provide a sealed relationship between the fuel cap 10 and the filler neck 14. The fuel cap 10 is removable to allow an operator to supply fuel to the fuel tank 16 via the filler neck 14. The fuel tank 16 may supply fuel to an internal combustion engine 18, installed in a vehicle (not shown), for example.

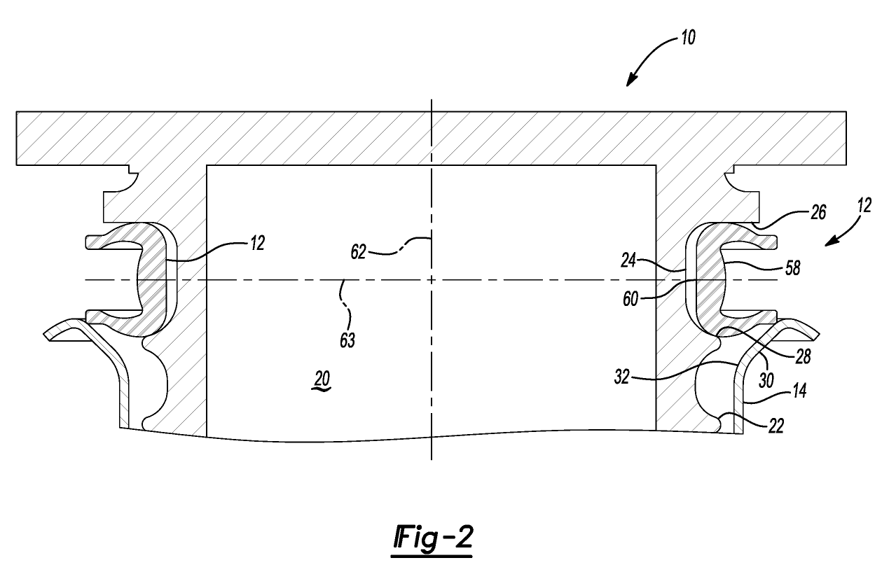

Referring now to FIG. 2, the fuel cap 10 may include a stem portion 20. The stem portion 20 may include male threads 22 operable to threadably engage corresponding female threads (not shown) disposed on the filler neck 14. The stem portion 20 may include an annular groove 24 adapted to receive the annular gasket 12. The annular groove 24 may be formed by an upper rim 26 and a lower rim 28. The annular groove 24 may be disposed directly adjacent to the male threads 22, as shown in FIG. 2.

The filler neck 14 includes an opening portion 30, which may be disposed adjacent to the female threads (not shown) operable to engage the male threads 22 of the cap 10. The opening portion 30 may be substantially bell-shaped, flaring outward as shown in FIG. 2. The opening portion 30 may include a seal surface 32, against which the annular gasket 12 is compressed, as will be subsequently described.

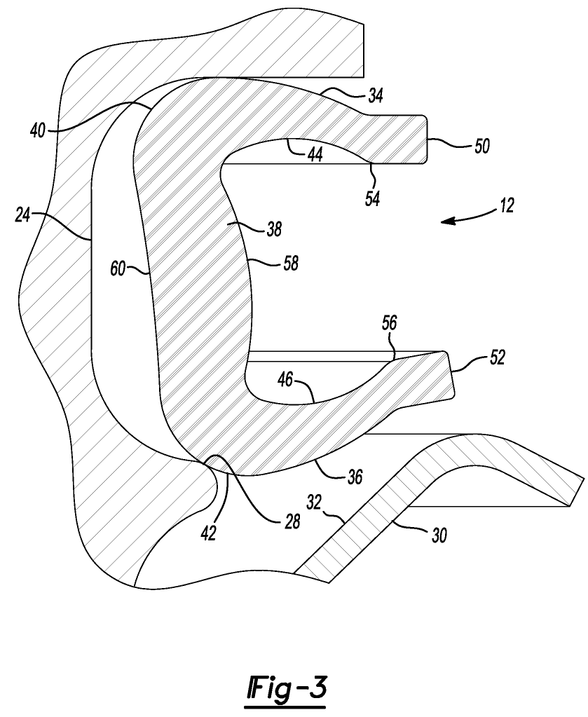

Referring now to FIG. 3, the annular gasket 12 includes an upper flange 34, a lower flange 36, and a body portion 38. The body portion 38 and the upper flange 34 may intersect to form an upper elbow 40. The body portion 38 and the lower flange 36 may intersect to form a lower elbow 42.

The upper and lower elbows 40, 42 form a junction between the body portion 38 and the upper and lower flanges 34, 36, respectively, to form a substantially horseshoe-shaped cross-section. The upper and lower flanges 34, 36 may be disposed substantially perpendicular to the body portion 38, as shown in FIG. 3.

The upper flange 34 may include an inner concave surface 44. The lower flange 36 may include an inner concave surface 46. The concave surfaces 44, 46 may face inwardly towards each other. The upper and lower flanges 34, 36 may also include an upper lip 50 and a lower lip 52, respectively. The lips 50, 52 may be disposed on the distal ends of the upper and lower flanges 34, 36. The lips 50, 52 may have generally rectangular cross sections. Convex radii 54, 56 may join the lips 50, 52 and the flanges 34, 36, respectively, as shown in FIG. 3. The flanges 34, 36 may be generally arch-shaped, and may taper between the elbows 40, 42 and the lips 50, 52 so as to provide a wider thickness at the elbows 40, 42 and a narrower thickness at the lips 50, 52.

The body portion 38 includes an outer diameter 58 and an inner diameter 60, wherein the inner diameter 60 is disposed between the outer diameter 58 and an axis of revolution 62 of the annular gasket 12 (shown in FIG. 2). The outer diameter 58 may be convex, and the inner diameter 60 may be concave, as shown in FIG. 3. A cross-sectional thickness of the body portion 38 may be greater than that of the upper or lower flanges 34, 36, as shown in FIG. 3 with a thickness at the elbows 40, 42 being narrower than the body portion 38.

The annular seal 12 is rotationally symmetric about the axis of revolution 62 (axis of rotational symmetry), shown in FIG. 2. The annular seal 12 may also be symmetric about a plane 63 bisecting the body portion 38, perpendicular to the axis of rotational symmetry 62. This symmetry allows the annular gasket to be installed in the fuel cap 10 with either side up (i.e. either elbow 40, 42 disposed against the lower rim 28), in accordance with “Poka-yoke” design methodology, to reduce inadvertent assembly errors. This interchangeable orientation of the annular gasket 12 may also be flipped if any part of the gasket 12 becomes excessively worn, increasing its operational life.

Referring now to FIGS. 2-4, the annular gasket 12 is seated in the annular groove 24 of the fuel cap 10. To seal the fuel cap 10 to the filler neck 14, an operator may grip the fuel cap 10 and insert the stem portion 20 into the filler neck 14. In this condition, the operator may turn the fuel cap 10 in a tightening direction in order to threadably engage the fuel cap 10 with the filler neck 14. In this manner, the fuel cap 10 tightens into the filler neck 14, which applies a compression force (or compression load) on the annular gasket 12. The compression load increases as the fuel cap 10 is tightened.

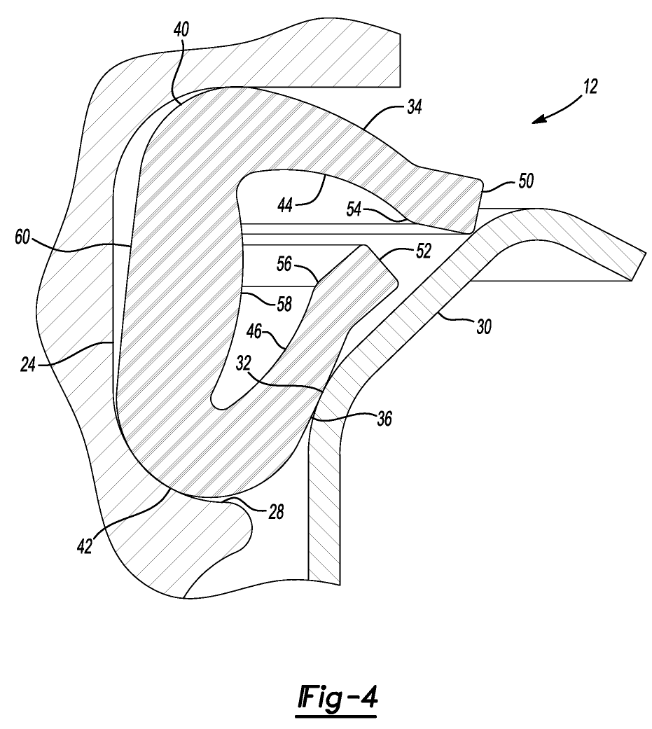

FIG. 4 shows the annular gasket 12 in its compressed state in a maximum load condition. As the fuel cap 10 tightens, the upper rim 26 of the annular groove 24 and the seal surface 32 apply a compression load to the annular gasket 12. The lower elbow 42 slides along the lower rim 28 and seats within the annular groove 24, as shown in FIG. 4, as the seal surface 32 of the filler neck 14 deflects the lower flange 36 inward in a pivoting fashion about the lower elbow 42, toward the body portion 38. The arched and tapered shape of the flanges 34, 36 facilitates their deflection under a reduced compression load. This decreases the torque that an operator must apply to the fuel cap 10 in order to ensure a sufficient compression load to provide an adequate seal.

The annular gasket 12 may be rubber or any other resilient elastomer suitable for its intended application, which in the present embodiment, may include suitability for exposure to fuel vapor. The elastic material and structural properties of the annular gasket 12 enable the flanges 34, 36 to apply a biasing force against the annular groove 24 and the seal surface 32. This biasing force ensures an adequate, leak-free seal.

The shape of the body portion 38, including the convex outer diameter 58 and the concave inner diameter 60, prevent the annular gasket 12 from buckling and/or bending at a point near the center of the body portion 38. Instead, the lower flange 36 bends at the lower elbow 42 and deflects inward towards the body portion 38. Consequently, only the elbows 40, 42 are compressed against the annular groove 24. The upper lip 50 of the upper flange 34 also contacts the seal surface 32 in the fully loaded configuration shown in FIG. 4. Therefore, the flanges 34, 36 do not compress against each other and do not create a suction force therebetween hindering a resilient return of the annular gasket 12 to its unloaded shape shown in FIG. 3.

The fuel cap 10 may be removed and fastened back onto the filler neck 14 repeatedly, as desired. When the compression load on the annular gasket 12 is removed, the annular gasket 12 will resiliently return to its original, unloaded shape shown in FIG. 3.

The annular gasket 12 described above may be used to seal any type of container, and is not limited in functionality or utility to fuel cap applications. In other embodiments, the gasket 12 may be linear, polygonal, oval, or any another shape suitable for a given application.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

1. An annular gasket comprising:
a first flange;
a second flange; and
a body portion connecting said first flange and said second flange via a first elbow and a second elbow respectively, forming a substantially horseshoe-shaped cross section,
wherein said body portion forms an inner diameter and an outer diameter, said outer diameter is convex and faces away from an axis of rotational symmetry of the annular gasket.

2. The annular gasket according to claim 1, wherein said first flange and said second flange are adapted for elastic deflection in an axial direction.

3. The annular gasket according to claim 2, wherein said first flange is adapted for pivotal deflection about said first elbow and said second flange is adapted for pivotal deflection about said second elbow.

4. The annular gasket according to claim 1, wherein a concave surface of said first flange faces a concave surface of said second flange.

5. The annular gasket according to claim 1, wherein said inner diameter of said body portion is concave, facing an axis of rotational symmetry.

6. The annular gasket according to claim 1, wherein said substantially horseshoe-shaped cross section is symmetric about a plane bisecting said body portion.

7. The annular gasket according to claim 6, wherein said plane is perpendicular to an axis of rotational symmetry.

8. (canceled)

9. The annular gasket according to claim 1, wherein said annular gasket is formed from an elastomeric material.

10. The annular gasket according to claim 1, wherein said first flange includes a first lip and said second flange includes a second lip.

11. The annular gasket according to claim 10, wherein a cross section of said first lip and a cross section of said second lip are substantially rectangular.

12.-17. (canceled)

18. A gasket comprising:
an upper flange;
a lower flange having a concave arched surface; and
a body portion connected to said upper flange by an upper elbow, said body portion connected to said lower flange by a lower elbow,
wherein said lower flange is pivotable about said lower elbow.

19. The gasket according to claim 18, wherein said upper flange includes a concave arched surface facing said concave arched surface of said lower flange.

20. The gasket according to claim 18, wherein said body portion includes a convex surface that faces in a direction of said lower flange.

21. The gasket according to claim 18, wherein said body portion includes a concave surface facing in a direction away from said lower flange.

22. The gasket according to claim 18, wherein said upper flange includes an upper lip portion, and said lower flange includes a lower lip portion.

23. The gasket according to claim 18, wherein said upper flange and said lower flange are tapered to facilitate pivotal deflection of said lower flange in response to a load.

24. The gasket according to claim 23, wherein said lower flange pivotally deflects about an elbow.

25. (canceled)
